(19) United States
(12) Patent Application Publication
(10) Pub. No.: US 2023/0211494 A1
(43) Pub. Date: Jul. 6, 2023

(54) MOBILE ROBOT, MOBILE ROBOT CONTROL METHOD, AND PROGRAM

(71) Applicant: SONY GROUP CORPORATION, TOKYO (JP)

(72) Inventors: ATSUSHI SUZUKI, TOKYO (JP); YASUNORI KAWANAMI, TOKYO (JP); JUN ARAI, TOKYO (JP); WILLIAM CONUS, TOKYO (JP); YOSHIKAZU FURUYAMA, TOKYO (JP); KAZUO HONGO, TOKYO (JP)

(21) Appl. No.: 18/001,093

(22) PCT Filed: Jun. 16, 2021
(86) PCT No.: PCT/JP2021/022806

§ 371 Date: Dec. 8, 2022

(30) Foreign Application Priority Data
Jun. 17, 2020 (JP) 2020-104712

(51) Int. Cl. B25J 9/16; B25J 5/00; B25J 13/08

(52) U.S. Cl. CPC B25J 9/161; B25J 5/00; B25J 9/1664; B25J 13/084

(57) ABSTRACT

To prevent scattering of scattered objects such as of water, sand, mud, or snow accompanied by movement.

Scattering prevention constraint information is acquired based on road surface information. Movement is controlled based on the scattering prevention constraint information. For example, vibration information is detected by a vibration sensor or the like, and road surface information (information such as a road surface depth and a road surface type) is acquired based on the vibration information.

### TECHNICAL FIELD

The present technology relates to mobile robots, mobile robot control methods, and programs, and more particularly to mobile robots and the like that prevent the scattering of scattered objects such as water, sand, mud, or snow accompanied by movement.

### BACKGROUND ART

Conventionally, mobile robots such as legged mobile robots have been proposed. When the mobile robot moves outdoors, if there are scattered objects such as water, sand, mud, or snow on the road surface, the scattered objects may be scattered to hit people or other objects.

For example, PTL 1 discloses a walking robot device that switches gaits (trotting, crawling) based on the gradient, unevenness, wetness, and the like of the road surface ahead. However, PTL 1 does not mention how to prevent the scattering of scattered objects such as water, sand, mud, or snow when there are such scattered objects on the road surface.

### CITATION LIST

### Patent Literature

[PTL 1]
JP 2006-255798 A

### SUMMARY

### Technical Problem

An object of the present technology is to prevent the scattering of scattered objects such as water, sand, mud, or snow accompanied by movement.

### Solution to Problem

A concept of the present technology is represented by a mobile robot, including: a constraint information acquisition unit that acquires scattering prevention constraint information based on road surface information; and a control unit that controls movement based on the scattering prevention constraint information.

In the present technology, the acquisition unit acquires the scattering prevention constraint information based on the road surface information. For example, the road surface information may include road surface type information. In this case, for example, the road surface information may further include road surface depth information. The control unit controls the movement based on the scattering prevention constraint information.

For example, a road surface information acquisition unit that acquires the road surface information may be further provided. By providing the road surface information acquisition unit in this way, it is possible to acquire the road surface information in real time. In this case, for example, a vibration detection unit that detects vibration information may be further provided, and the road surface information acquisition unit may acquire road surface information based on the vibration information. Here, the vibration detection unit may be configured using, for example, a vibration sensor, a force sensor, or a microphone.

For example, a vibration application unit that applies vibration to the road surface may be further provided. By providing the vibration application unit in this way, it is possible to acquire road surface information satisfactorily based on the vibration information. In this case, for example, the mobile robot may be a legged mobile robot, and the vibration application unit may apply vibration to the road surface by vibrating joints of a leg. In this case, for example, the vibration application unit may use a vibrator to apply vibration to the road surface.

In this case, for example, the vibration application unit may change an amplitude or frequency of the applied vibration based on the acquired road surface information. In this way, it is possible to improve the accuracy of road surface information recognized based on the vibration information.

For example, the mobile robot may be a legged mobile robot, and the control unit may control leg movement. In this case, for example, the scattering prevention constraint information may include information on at least one of a leg tip speed constraint when landing on a floor, a leg tip speed constraint when leaving the floor, a leg tip attitude angle constraint when landing on the floor, a leg tip attitude angle constraint when leaving the floor, and a leg raising height constraint of a swing leg.

As described above, in the present technology, the movement is controlled based on the scattering prevention constraint information acquired based on the road surface information. Therefore, it is possible to prevent the scattering of scattered objects such as water, sand, mud, or snow accompanied by movement.

### BRIEF DESCRIPTION OF DRAWINGS

FIG. 1 is a diagram showing a configuration example of a bipedal mobile robot.

FIG. 2 is a block diagram showing a configuration of a control system of the bipedal mobile robot.

FIG. 3 is a flowchart showing an example of a procedure for estimating a road surface type.

FIG. 4 is a diagram showing a specific calculation example of scattering prevention constraint (scattering risk) calculation.

FIG. 5 is a flowchart showing an example of the processing of the control system for a leg (support leg) in a support phase.

FIG. 6 is a flowchart showing an example of the processing of the control system for a leg (swing leg) in a swing phase.

FIG. 7 is a diagram showing an example in which the leg tip activation of the swing leg changes with the update of the scattering prevention constraint.

FIG. 8 is a diagram showing another configuration example of a bipedal mobile robot.

FIG. 9 is a diagram showing another configuration example of a bipedal mobile robot.

FIG. 10 is a diagram showing another configuration example of a bipedal mobile robot.

FIG. 11 is a diagram showing another configuration example of a quadruped mobile robot.

### DESCRIPTION OF EMBODIMENTS

Modes for carrying out the present invention (hereinafter referred to as “embodiments”) will be described hereinafter. The descriptions will be given in the following order.

### 1. Embodiment

### 2. Modification Example

### 1. Embodiment

“Appearance of Legged Mobile Robot”

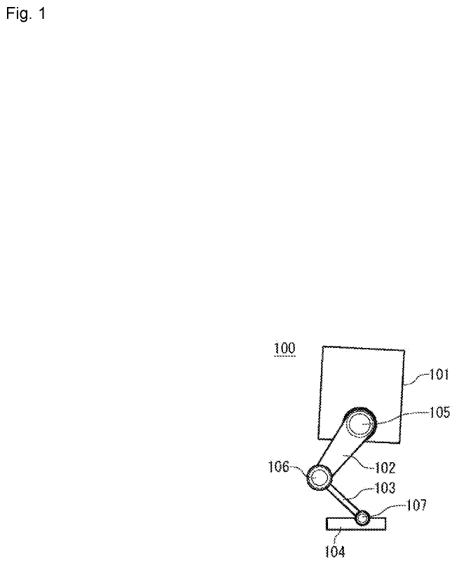

FIG. 1 shows a configuration example of a bipedal mobile robot 100. This bipedal mobile robot 100 has a main body 101, legs 102 and 103, a foot 104, and joints 105, 106 and 107. The figure does not show the second opposing leg.

The joint 105 connects the main body 101 and the leg 102. The joint 106 connects the legs 102 and 103. The joint 107 connects the leg 103 and the foot 104. Each joint has an actuator (motor) and an encoder for detecting the position of the actuator. A vibration sensor is mounted on the foot 104.

Each leg preferably has three or more degrees of freedom. In addition, each leg can dynamically change the angle during the leg tip movement when landing on and leaving the floor, and dynamically change the leg raising height. Moreover, each leg can apply vibration to the ground surface by vibrating the joint of the ground leg (support leg) when grounded.

“Control System Configuration of Legged Mobile Robot”

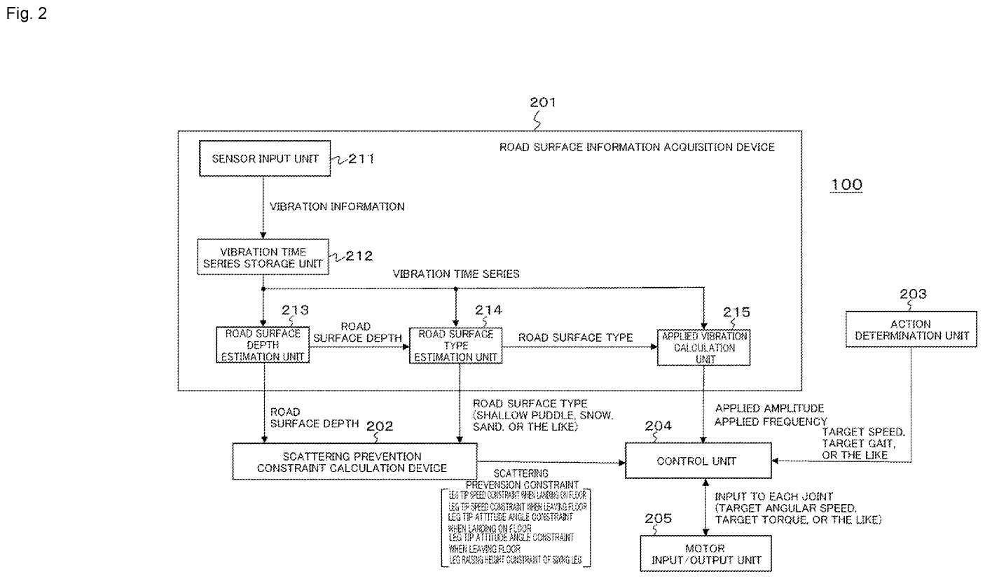

FIG. 2 is a block diagram showing the configuration of a control system of the bipedal mobile robot 100. The bipedal mobile robot 100 has a road surface information acquisition device 201, a scattering prevention constraint calculation device 202, an action determination unit 203, a control unit 204, and a motor input/output unit 205. This control system is configured of, for example, a computer (microcomputer) provided in the main body 101. This computer executes the functions of each unit of the control system based on programs stored in, for example, a ROM.

The road surface information acquisition device 201 estimates road surface information (information on a road surface type and a road surface depth) based on the vibration information obtained by the vibration sensor mounted on the foot 104, and calculates the amplitude and frequency of the vibration applied to the road surface.

The road surface information acquisition device 201 has a sensor input unit 211, a vibration time series storage unit 212, a road surface depth estimation unit 213, a road surface type estimation unit 214, and an applied vibration calculation unit 215. The sensor input unit 211 inputs vibration information (frequency and amplitude) obtained by the vibration sensor mounted on the foot 104. The vibration time series storage unit 212 samples the vibration information (frequency and amplitude) input to the sensor input unit 211 at high speed, and stores sampling values for a certain past period as a vibration time series.

The road surface depth estimation unit 213 estimates the road surface depth based on the vibration time series stored in the vibration time series storage unit 212. In this case, based on the vibration time series related to the vibration information obtained by the vibration sensor mounted on the foot 104 of the swing leg (the leg on the side away from the road surface), the road surface depth is estimated from a difference between a leg tip height when the leg tip of the swing leg plunges into a liquid surface and a leg tip height when the leg tip of the swing leg contacts the road surface.

The road surface type estimation unit 214 estimates the road surface type based on the vibration time series stored in the vibration time series storage unit 212 and the road surface depth estimated by the road surface depth estimation unit 213. In this case, the road surface type is estimated based on the vibration time series related to the vibration information obtained by the vibration sensor mounted on the foot 104 of the support leg (the leg on the side of the road surface) and the road surface depth estimated by the estimation unit 213.

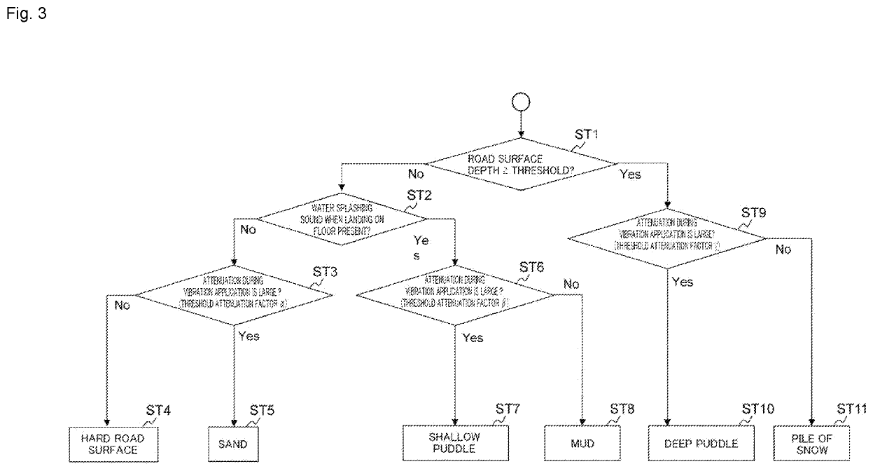

The flowchart in FIG. 3 shows an example of the road surface type estimation procedure. First, in step ST1, the road surface type estimation unit 214 determines whether the road surface depth is equal to or greater than a threshold. When it is determined that the road surface depth is not equal to or greater than the threshold, the road surface type estimation unit 214 determines in step ST2 whether there was a water splashing sound when landing on the floor.

When it is determined that there was no water splashing sound when landing on the floor, the road surface type estimation unit 214 determines in step ST3 whether the attenuation at the time of vibration application is large, that is, whether the attenuation factor is greater than a threshold attenuation factor α. When the attenuation is small, the road surface type estimation unit 214 estimates that the road surface is hard in step ST4. On the other hand, when the attenuation is large, the road surface type estimation unit 214 estimates that the road surface is sand in step ST5.

When it is determined in step ST2 that there is a water splashing sound at the time of landing on the floor, the road surface type estimation unit 214 determines in step ST4 whether the attenuation when the vibration is applied is large, that is, whether the attenuation factor is greater than a threshold attenuation factor β. When the attenuation is large, the road surface type estimation unit 214 estimates that the road surface is a shallow puddle in step ST7. On the other hand, when the attenuation is small, the road surface type estimation unit 214 estimates that the road surface is mud in step ST8.

When it is determined in step ST1 that the road surface depth is equal to or greater than the threshold, the road surface type estimation unit 214 determines in step ST9 whether the attenuation at the time of vibration application is large, that is, whether the attenuation factor is greater than a threshold attenuation factor γ. When the attenuation is large, the road surface type estimation unit 214 estimates that the road surface is a deep puddle in step ST11. On the other hand, when the attenuation is small, the road surface type estimation unit 214 estimates that the road surface is a pile of snow in step ST11.

Returning to FIG. 2, the applied vibration calculation unit 215 calculates the amplitude and frequency of the vibration to be applied to the road surface based on the vibration time series stored in the vibration time series storage unit 212 and the road surface type estimated by the road surface type estimation unit 214. In this case, the amplitude and frequency that should be applied in order for the road surface type estimation unit 214 to estimate the current road surface type more correctly are calculated. In this case, it is conceivable to calculate only the amplitude of vibration or only the frequency of vibration.

The scattering prevention constraint calculation device 202 calculates scattering prevention constraints (constraint parameters) based on the road surface depth and road surface type estimated by the road surface information acquisition device 201. The scattering prevention constraints include a leg tip speed constraint when landing on the floor, a leg tip speed constraint when leaving the floor, a leg tip attitude angle constraint when landing on the floor, a leg tip attitude angle constraint when leaving the floor, and a leg raising height constraint of swing legs. It should be noted that it is not necessary to include all of these constraints, and at least any one of these constraints should be included.

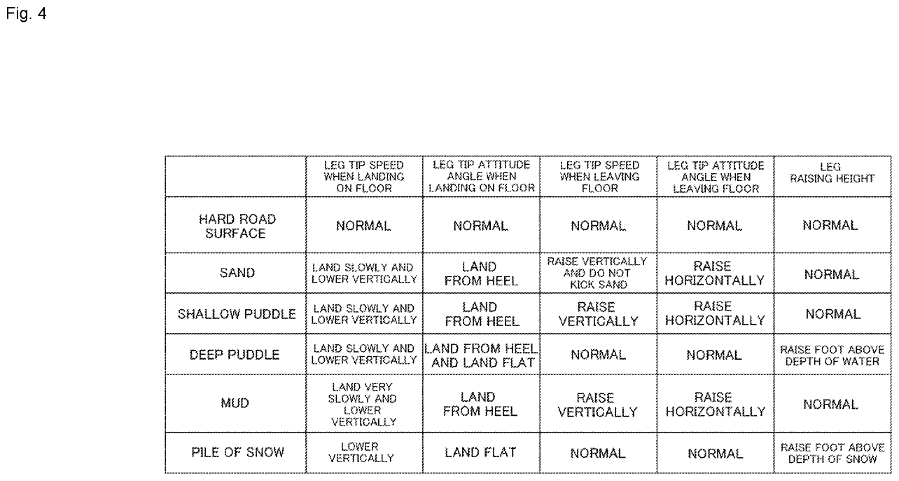

FIG. 4 shows a specific calculation example of scattering prevention constraint (scattering risk) calculation. For example, if the road surface is hard, the constraint parameters are calculated such that the leg tip speed when landing on the floor is “normal”, the leg tip attitude angle when landing on the floor is “normal”, the leg tip speed when leaving the floor is “normal”, the leg tip attitude angle when leaving the floor is “normal”, and the leg raising height is “normal”.

Also, for example, when the road surface is sand, the constraint parameters are calculated such that the leg tip speed when landing on the floor is “land slowly and lower vertically”, the leg tip attitude angle when landing on the floor is “land from the heel”, the leg tip speed when leaving the floor is “raise vertically and do not kick sand”, the leg tip attitude angle when leaving the floor is “raise horizontally”, and the leg raising height is “normal”.

Also, for example, when the road surface is a shallow puddle, the constraint parameters are calculated such that the leg tip speed when landing on the floor is “land slowly and lower vertically”, the leg tip attitude angle when landing on the floor is “land from the heel”, the leg tip speed when leaving the floor is “raise vertically”, the leg tip attitude angle when leaving the floor is “raise horizontally”, and the leg raising height is “normal”.

Also, for example, when the road surface is a deep puddle, the constraint parameters are calculated such that the leg tip speed when landing on the floor is “land slowly and lower vertically”, the leg tip attitude angle when landing on the floor is “land from the heel and land flat”, the leg tip speed when leaving the floor is “normal”, the leg tip attitude angle when leaving the floor is “normal”, and the leg raising height is “raise the foot above the depth of the water”.

For example, when the road surface is mud, the constraint parameters are calculated such that the leg tip speed when landing on the floor is “land very slowly and lower vertically”, the leg tip attitude angle when landing on the floor is “land from the heel”, the leg tip speed when leaving the floor is “raise vertically”, the leg tip attitude angle when leaving the floor is “raise horizontally”, and the leg raising height is “normal”.

Also, for example, when the road surface is a pile of snow, the constraint parameters are calculated such that the leg tip speed when landing on the floor is “lower vertically”, the leg tip attitude angle when landing on the floor is “land flat”, the leg tip speed when leaving the floor is “normal”, the leg tip attitude angle when leaving is “normal”, and the leg raising height is “raise the foot above the depth of the snow”.

Returning to FIG. 2, the control unit 204 determines signals to be input to the motors (actuators) of each joint, and sends the signals to the motor input/output unit 205. In this case, the target values applied to the motor are target angular speed, target torque, and the like. The control unit 204 calculates these target values using information such as the target speed and the target gait instructed by the action determination unit 203, information on the amplitude and frequency of the vibration to be applied calculated by the road surface information acquisition device 201, and information on the scattering prevention constraint calculated by the constraint calculation device 202.

“Control System Processing Flow”

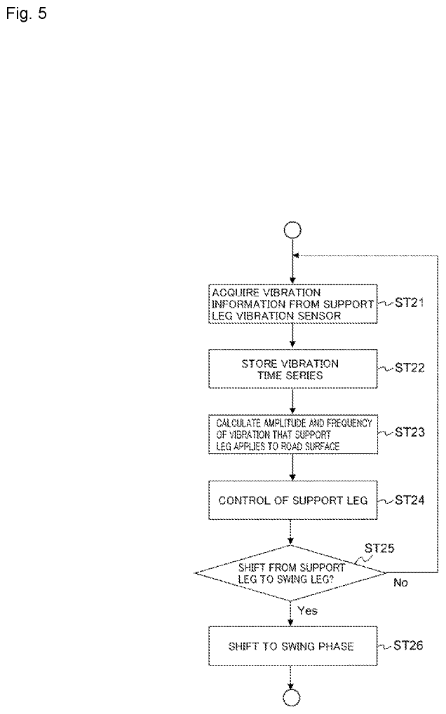

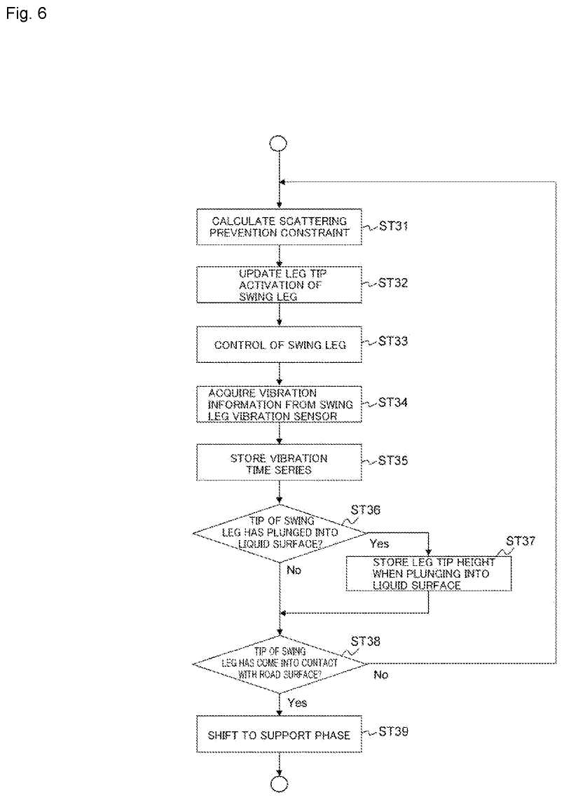

Each leg of the bipedal mobile robot 100 moves in a desired direction by switching between a support phase and a swing phase. The flowchart of FIG. 5 shows an example of the processing of the control system (see FIG. 2) on the leg in the support phase, that is, the support leg. The flowchart of FIG. 6 shows an example of the processing of the control system (see FIG. 2) for the leg in the swing phase, that is, the swing leg. The processing of the flowcharts of FIGS. 5 and 6 is performed during each tick loop.

The control flow for the support leg, that is, the leg in the support phase will be described with reference to the flowchart of FIG. 5. First, in step ST21, vibration information is acquired from the vibration sensor mounted on the foot 104 of the support leg. Next, in step ST22, the vibration information (frequency and amplitude) is sampled at high speed, and sampled values for a certain past period are stored as a vibration time series.

Next, in step ST23, the amplitude and frequency of the vibration to be applied to the road surface are calculated based on the estimated road surface type and the vibration time series obtained from the vibration information of the vibration sensor of the support leg. Next, in step ST24, control of the support leg, that is, control of the position of the leg for walking, and control of vibrating the leg (joint) in order to apply vibration of the calculated amplitude and frequency to the road surface are performed.

Next, in step ST25, it is determined whether the support leg should be shifted to the swing leg. In this case, when the tip of the swing leg comes into contact with the road surface, it is determined that the support leg is shifted to the swing leg. When it is determined that the support leg will not be shifted to the swing leg, the processing returns to step ST21, and the same processing as described above is repeated. On the other hand, when it is determined that the support leg is shifted to the swing leg, the leg shifts to the swing phase in step ST26. In other words, the leg that has been the support leg until now becomes the swing leg, and the control flow for the swing leg, that is, the leg in the swing phase is applied.

The control flow for the swing leg, that is, the leg in the swing phase will be described with reference to the flowchart of FIG. 6. First, in step ST31, as will be described later, the scattering prevention constraints are calculated based on the road surface depth estimated based on the vibration time series obtained from the vibration information of the vibration sensor of the swing leg, and the road surface type estimated based on the road surface depth and the vibration time series obtained from the vibration information of the vibration sensor of the support leg.

Next, in step ST32, the information on leg tip activation (leg tip speed, leg tip attitude angle, and leg raise height) is updated based on the calculated scattering prevention constraints. For example, when the hard road surface changes to a shallow puddle, the scattering prevention constraints are updated from those of the hard road surface to those of the shallow puddle (see FIG. 4). At this time, the leg tip activation is updated from one corresponding to a hard road surface to one corresponding to a shallow puddle.

Next, in step ST33, control of the swing leg, that is, control of the position of the leg for walking is performed. In this case, the leg tip activation is controlled so that the updated leg tip activation described above is performed. For example, when the leg tip activation is updated to one corresponding to a shallow puddle, the leg tip speed when landing on the floor is controlled to satisfy “land slowly and lower vertically”, and the leg tip attitude angle when landing on the floor is controlled to satisfy “land from the heel”.

Further, for example, when the leg tip activation is updated to one corresponding to a shallow puddle, the leg tip speed when leaving the floor is controlled to satisfy “raise vertically”, and the leg tip attitude angle when leaving the floor is controlled to satisfy “raise horizontally”. Further, for example, when the leg tip activation is updated to one corresponding to a shallow puddle, the leg raising height after leaving the floor is controlled to satisfy “normal”.

Next, in step ST34, vibration information is acquired from the vibration sensor mounted on the foot 104 of the swing leg. Next, in step ST35, vibration information (frequency and amplitude) is sampled at high speed, and sampled values for a certain past period are stored as a vibration time series.

Next, in step ST36, it is determined whether the tip of the swing leg has plunged into a liquid surface based on the vibration time series obtained from the vibration information of the vibration sensor of the swing leg. When it is determined that it has plunged into the liquid surface, the leg tip height at the time of plunging into the liquid surface is stored in step ST37, and then the processing proceeds to step ST38. If it is determined that it has not plunged into the liquid surface, the processing immediately proceeds to step ST38.

Next, in step ST38, based on the vibration time series obtained from the vibration information of the vibration sensor of the swing leg, it is determined whether the tip of the swing leg has come into contact with the road surface. When it is determined that the leg tip is not in contact with the road surface, the processing returns to step ST31 and repeats the same processes as described above. On the other hand, when it is determined that the leg tip has come into contact with the road surface, the leg shifts to the support phase in step ST39. In other words, the leg that has been the swing leg until now becomes the support leg, and the control flow for the support leg, that is, the leg in the support phase is applied.

The road surface depth is estimated based on the difference between the leg tip height when the tip of the swing leg has plunged into the liquid surface and the leg tip height when the tip of the swing leg comes into contact with the road surface.

As shown in the flowchart of FIG. 6, information on the leg tip activation (leg tip speed, leg tip attitude angle, and leg raising height) of the swing leg is updated according to the scattering prevention constraints calculated based on the road surface information (road surface depth and road surface type) and the leg tip activation of the swing leg is controlled according to the update. Therefore, even if a scattered object such as water, sand, mud, or snow is present on the road surface, it is possible to prevent the scattering of the scattered object.

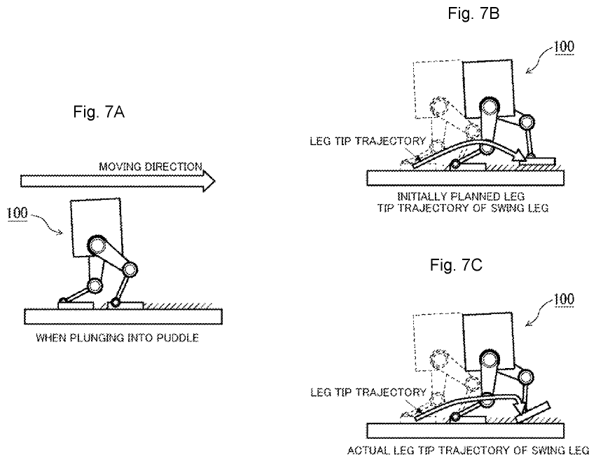

FIG. 7 shows an example in which the leg tip activation of the swing leg changes as the scattering prevention constraint is updated. FIG. 7(a) shows a state when the bipedal mobile robot 100 plunges into a puddle. This state is a state in which the robot lands on a puddle for the first time from a state in which it has never been in a puddle. At this point of time, the bipedal mobile robot 100 does not yet know that it has landed on the puddle.

The arrow in FIG. 7(b) indicates the initially planned leg tip activation of the swing leg. The arrow in FIG. 7(c) indicates the actual leg tip activation of the swing leg that changes with the update of the scattering prevention constraints. In this case, the initial trajectory is the same as the initially planned leg tip activation in FIG. 7(b). However, since the scattering prevention constraints are later updated to those corresponding to puddles, the leg tip activation changes to be different from the initially planned leg tip activation to prevent splashing of water in puddles. In this case, for example, when the puddle is shallow, the leg tip speed when landing on the floor changes to “land slowly and lower vertically”, and the leg tip attitude angle when landing on the floor changes to “land from the heel”.

As described above, in the bipedal mobile robot 100 shown in FIG. 1, movement is controlled based on scattering prevention constraint information acquired based on the road surface information. Even if there are scattered objects such as water, sand, mud, or snow on the road surface, it is possible to suppress scattering of the scattered objects accompanied by the movement.

The bipedal mobile robot 100 shown in FIG. 1 includes the road surface information acquisition device 201 that estimates the road surface information (information on the road surface type and the road surface depth) based on the vibration information obtained by the vibration sensor mounted on the foot 104. Thus, it is possible to acquire the road surface information in real time.

In the bipedal mobile robot 100 shown in FIG. 1, the road surface information acquisition device 201 calculates the amplitude and frequency of the vibration to be applied to the road surface based on the road surface type information and the vibration time series, controls the vibration of the joint using the calculation results, and applies vibration to the road surface. Thus, it is possible to obtain more accurate road surface information based on the vibration information obtained by the vibration sensor.

### 2. Modification Example

In the above-described embodiment, an example of using road surface information (information on road surface type and road surface depth) obtained in real time based on vibration information obtained by the vibration sensor mounted on the foot 104 is shown. However, it is conceivable that road surface information corresponding to the movement path of the bipedal mobile robot 100 is provided in advance and used.

In the above-described embodiment, an example in which vibration information is detected by the vibration sensor mounted on the foot 104 is shown, but instead of the vibration sensor, a force sensor or a microphone may be used to detect vibration information.

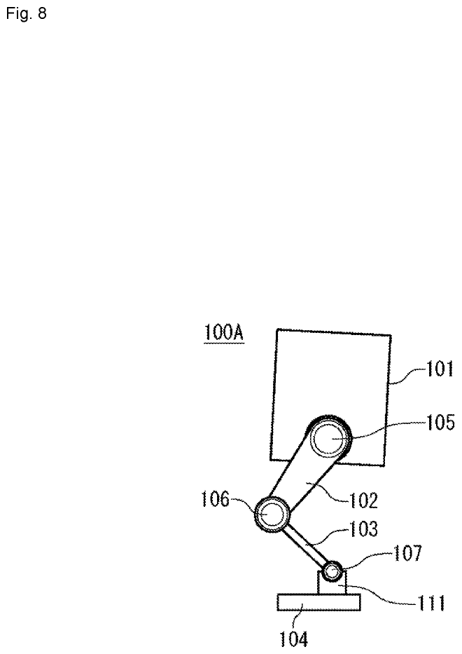

A bipedal mobile robot 100A in FIG. 8 shows an example in which vibration information is detected by a force sensor 111 mounted on the ankle. In FIG. 8, parts corresponding to those in FIG. 1 are denoted by the same reference numerals, and detailed description thereof will be omitted. When the force sensor 111 is configured to detect vibration information in this manner, the force sensor 111 can also measure the leg tip force of the bipedal mobile robot 100 at the same time.

In the above-described embodiment, an example of acquiring road surface information based on vibration information detected by a vibration sensor has been shown, but road surface information can also be acquired based on other sensor information such as an image sensor.

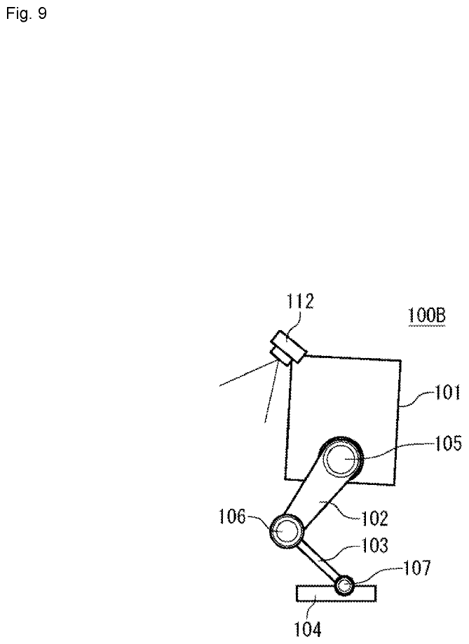

A bipedal mobile robot 100B shown in FIG. 9 shows an example in which a camera (image sensor) 112 is attached to the main body 101, and road surface information is acquired based on an imaging signal of the camera 112. In FIG. 9, parts corresponding to those in FIG. 1 are denoted by the same reference numerals, and detailed description thereof will be omitted.

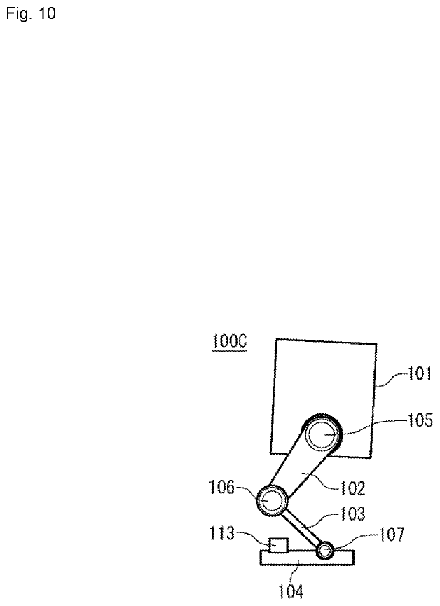

In the above-described embodiment, an example in which vibration is imparted (applied) to the road surface by vibrating the joints has been shown, but it is also conceivable to impart vibration to the road surface with other configurations. A bipedal mobile robot 100C of FIG. 10 shows an example in which a vibrator 113 is attached to the foot 104 and vibrates the vibrator 113 to apply vibration to the road surface. In FIG. 10, parts corresponding to those in FIG. 1 are denoted by the same reference numerals, and detailed description thereof will be omitted.

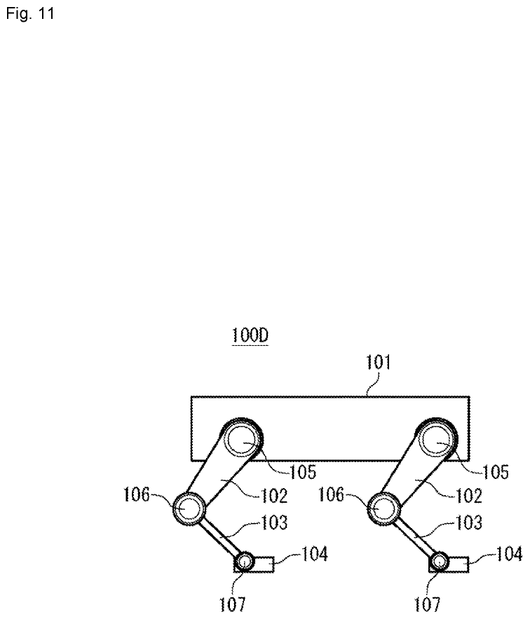

In the above-described embodiment, an example of a bipedal mobile robot is shown, but the present technology can be similarly applied to a legged mobile robot other than a bipedal mobile robot. FIG. 11 shows, for example, a configuration example of a quadruped mobile robot 100D. In FIG. 11, parts corresponding to those in FIG. 1 are denoted by the same reference numerals, and detailed description thereof will be omitted.

The control system configuration and processing flow of this quadruped mobile robot 100D are the same as those of the bipedal mobile robot 100 shown in FIG. 1, although the number of legs is different. In this case the processing flow for the support leg and the swing leg shown in FIGS. 5 and 6 is executed for the respective swing legs and support legs, whereby the road surface information can be acquired and the leg movement with suppressed scattering can be realized based on the road surface information similarly to the case of the bipedal mobile robot 100.

In the above embodiments, an example of a legged mobile robot is shown, but the present technology can be similarly applied to a mobile robot that moves using other moving parts such as wheels instead of legs.

Although preferred embodiments of the present disclosure have been described in detail with reference to the accompanying drawings as described above, the technical scope of the present disclosure is not limited to such examples. It is apparent that those having ordinary knowledge in the technical field of the present disclosure could conceive various modified examples or changed examples within the scope of the technical ideas set forth in the claims, and it should be understood that these also naturally fall within the technical scope of the present disclosure.

Further, the effects described in the present specification are merely explanatory or exemplary and are not intended as limiting. That is, the techniques according to the present disclosure may exhibit other effects apparent to those skilled in the art from the description herein, in addition to or in place of the above effects.

In addition, the present technology can also adopt the following configurations.

(1) A mobile robot including: a constraint information acquisition unit that acquires scattering prevention constraint information based on road surface information; and a control unit that controls movement based on the scattering prevention constraint information.

(2) The mobile robot according to (1), further including: a road surface information acquisition unit that acquires the road surface information.

(3) The mobile robot according to (2), further including: a vibration detection unit that detects vibration information, wherein the road surface information acquisition unit acquires the road surface information based on the vibration information.

(4) The mobile robot according to (3), wherein the vibration detection unit is configured using a vibration sensor, a force sensor, or a microphone.

(5) The mobile robot according to (3) or (4), wherein further including: a vibration application unit that applies vibration to the road surface.

(6) The mobile robot according to (5), wherein the mobile robot is a legged mobile robot, and the vibration application unit applies vibration to the road surface by vibrating joints of a leg.

(7) The mobile robot according to (5), wherein the vibration application unit uses a vibrator to apply vibration to the road surface.

(8) The mobile robot according to any one of (5) to (7), wherein the vibration application unit changes an amplitude or frequency of the applied vibration based on the acquired road surface information.

(9) The mobile robot according to any one of (1) to (8), wherein the road surface information includes road surface type information.

(10) The mobile robot according to (9), wherein the road surface information further includes road surface depth information.

(11) The mobile robot according to any one of (1) to (10), wherein the mobile robot is a legged mobile robot, and the control unit controls leg movement.

(12) The mobile robot according to (11), wherein the scattering prevention constraint information includes information on at least one of a leg tip speed constraint when landing on a floor, a leg tip speed constraint when leaving the floor, a leg tip attitude angle constraint when landing on the floor, a leg tip attitude angle constraint when leaving the floor, and a leg raising height constraint of a swing leg.

(13) A mobile robot control method including: a procedure of acquiring scattering prevention constraint information based on road surface information; and a procedure of controlling movement based on the scattering prevention constraint information.

(14) A program causing a computer to function as:

an acquisition means for acquiring scattering prevention constraint information based on road surface information; and

a control means for controlling movement of a mobile robot based on the scattering prevention constraint information.

### REFERENCE SIGNS LIST

100, 100A, 100B, 100C Bipedal mobile robot
100D Quadruped mobile robot
101 Main body
102, 103 Leg
104 Foot
105, 106, 107 Joint
111 Force sensor
112 Camera (image sensor)
113 Vibrator
201 Road surface information acquisition device
202 Scattering prevention constraint calculation device
203 Action determination unit
204 Control unit
205 Motor input/output unit
211 Sensor input unit
212 Vibration time series storage unit
213 Road surface depth estimation unit
214 Road surface type estimation unit
215 Applied vibration calculation unit

1. A mobile robot comprising:
a constraint information acquisition unit that acquires scattering prevention constraint information based on road surface information; and
a control unit that controls movement based on the scattering prevention constraint information.

2. The mobile robot according to claim 1, further comprising:
a road surface information acquisition unit that acquires the road surface information.

3. The mobile robot according to claim 2, further comprising:
a vibration detection unit that detects vibration information, wherein
the road surface information acquisition unit acquires the road surface information based on the vibration information.

4. The mobile robot according to claim 3, wherein
the vibration detection unit is configured using a vibration sensor, a force sensor, or a microphone.

5. The mobile robot according to claim 3, wherein further comprising:
a vibration application unit that applies vibration to the road surface.

6. The mobile robot according to claim 5, wherein
the mobile robot is a legged mobile robot, and
the vibration application unit applies vibration to the road surface by vibrating joints of a leg.

7. The mobile robot according to claim 5, wherein
the vibration application unit uses a vibrator to apply vibration to the road surface.

8. The mobile robot according to claim 5, wherein
the vibration application unit changes an amplitude or frequency of the applied vibration based on the acquired road surface information.

9. The mobile robot according to claim 1, wherein
the road surface information includes road surface type information.

10. The mobile robot according to claim 9, wherein
the road surface information further includes road surface depth information.

11. The mobile robot according to claim 1, wherein
the mobile robot is a legged mobile robot, and
the control unit controls leg movement.

12. The mobile robot according to claim 11, wherein
the scattering prevention constraint information includes information on at least one of a leg tip speed constraint when landing on a floor, a leg tip speed constraint when leaving the floor, a leg tip attitude angle constraint when landing on the floor, a leg tip attitude angle constraint when leaving the floor, and a leg raising height constraint of a swing leg.

13. A mobile robot control method comprising:
a procedure of acquiring scattering prevention constraint information based on road surface information; and
a procedure of controlling movement based on the scattering prevention constraint information.

14. A program causing a computer to function as:
an acquisition means for acquiring scattering prevention constraint information based on road surface information; and
a control means for controlling movement of a mobile robot based on the scattering prevention constraint information.
